(19) United States
(12) Patent Application Publication
(10) Pub. No.: US 2006/0239346 A1
(43) Pub. Date: Oct. 26, 2006

(54) Picture encoding device

(75) Inventors: Haruhisa Kato, Fujimino-shi (JP); Yasuhiro Takishima, Fujimino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/410,075

(22) Filed: Apr. 25, 2006

(30) Foreign Application Priority Data
Apr. 26, 2005 (JP) 2005-127833

(51) Int. Cl. H04N 11/04; H04N 7/12; H04B 1/66; H04N 11/02

(52) U.S. Cl. 375/240.03; 375/240.18; 375/240.12

(57) ABSTRACT

Separating means 11 separates a picture signal into a reference signal and one or more signals to be predicted. A reference signal including a quantization error is outputted from inverse converting means 18. Predicting means 14 estimates one or more prediction coefficients for approximating the signal to be predicted based on the reference signal including the quantization error. Compensating means 19 generates a prediction signal of the signal to be predicted. Difference calculating means 13 generates a prediction error signal. The prediction error signal is processed and outputted by the converting means 12, quantizing means 15 and encoding means 16.

### BACKGROUND OF THE INVENTION

1. Field of the Invention

The present invention relates to a picture encoding device, more particularly, to a picture encoding device that predicts an object to be encoded from correlative information as to each picture and encodes a prediction error.

2. Description of the Related Art

A method for reducing temporal redundancy and a method for reducing spatial redundancy have been conventionally known as a method for improving encoding efficiency in picture encoding.

A frame difference method or a motion compensation method is employed as a method for reducing temporal redundancy. In the frame difference method, a simple subtraction between successive two pictures is performed, and the obtained difference is encoded. Additionally, in the motion compensation method, a motion vector is applied to a reference frame so that an approximate picture of a frame to be encoded is generated, and a difference between the approximate image and the frame to be encoded is encoded.

Since the motion compensation method reduces a difference between pictures and encodes the difference, it is more excellent than the frame difference method in terms of the encoding efficiency. Various methods have been proposed as an estimation method for the motion vector used for the motion compensation method, the leading patents regarding the motion estimation are disclosed in the following URL (Patent Reference 1).

On the other hand, a method for quantizing orthogonal transform coefficients is employed as a method for reducing spatial redundancy. In the orthogonal transform, a pixel signal is mapped on to a frequency domain and the energy is concentrated into the low frequency domain. The insensitivity of a visual characteristic of a human to the high frequency domain is used and high frequency components are removed by the quantization so that the encoding efficiency can be improved. The leading patents regarding the orthogonal transform are disclosed in the following URL (Patent Reference 2).

Patent Reference 1
http://www.jpo.go.jp/shiryou/s sonota/map/denki 14/2/2-1-2-1.htm

Patent Reference 2
http://www.jpo.go.jp/shiryou/s sonota/map/denki 14/2/2-1-3.htm

However, according to the conventional frame difference method or the motion compensation method, although the temporal redundancy can be reduced, the redundancy in one picture cannot be reduced in a picture signal such as an RGB signal, YUV signal or YCbCr signal, which is constituted by a plurality of signals.

On the other hand, according to the method for quantizing the orthogonal transform coefficients, although the spatial redundancy can be reduced, high frequency components are removed. Therefore, there remains a problem that picture regions such as edge regions, of which the variation is extreme, become blurred. Additionally, the redundancy in one picture cannot also be reduced in the picture signal constituted by the plurality of signals even according to this method.

### SUMMARY OF THE INVENTION

It is an object of the present invention to solve the above problems and to provide a picture encoding device capable of obtaining a high encoding efficiency without blurring a picture by a method for reducing redundancy between signals for every image.

In order to accomplish the object, the feature of this invention is that a picture encoding device comprises separating means for separating a picture signal into a reference signal and one or more signals to be predicted for every picture, converting means for performing orthogonal transform of the reference signal or a prediction error signal and outputting a transform coefficients, quantizing means for quantizing the transform coefficients and outputting quantized transform coefficients, encoding means for encoding the quantized transform coefficients, inverse quantizing means for inversely quantizing only the transform coefficients of the reference signal among the quantized transform coefficients, inverse transforming means for inversely transforming the inversely quantized transform coefficients and outputting the reference signal including quantization error, predicting means for estimating prediction coefficient for approximating the signal to be predicted based on the reference signal including the quantization error, compensating means for generating a prediction signal of a signal to be predicted from the reference signal including the quantization error and the prediction coefficient, and difference calculating means for calculating a difference between the signal to be predicted and the prediction signal and using the difference as the prediction error signal.

In the present invention, an input picture signal may be a signal mapped on to an arbitrary color space such as an RGB signal, YUV signal or YCbCr signal, or may be a signal constituted by orthogonal transform coefficients. Additionally, an arbitrary prediction method may be used in the predicting means.

In the present invention, the input picture signal is separated into a reference signal and a signal to be predicted for every picture, and the signal to be predicted is predicted based on the reference signal so that the generation amount of information in the signal to be predicted is reduced. Since there is a high relativity between the reference signal and the signal to be predicted, the high encoding efficiency can be obtained and the picture is not blurred. The present invention can be combined with a conventional prediction method for reducing temporal redundancy, and a further high encoding efficiency can be obtained by the combination.

### BRIEF DESCRIPTION OF THE DRAWINGS

FIG. 1 is a block diagram showing an embodiment of a picture encoding device according to the present invention.

### DETAILED DESCRIPTION OF THE PREFERRED EMBODIMENT

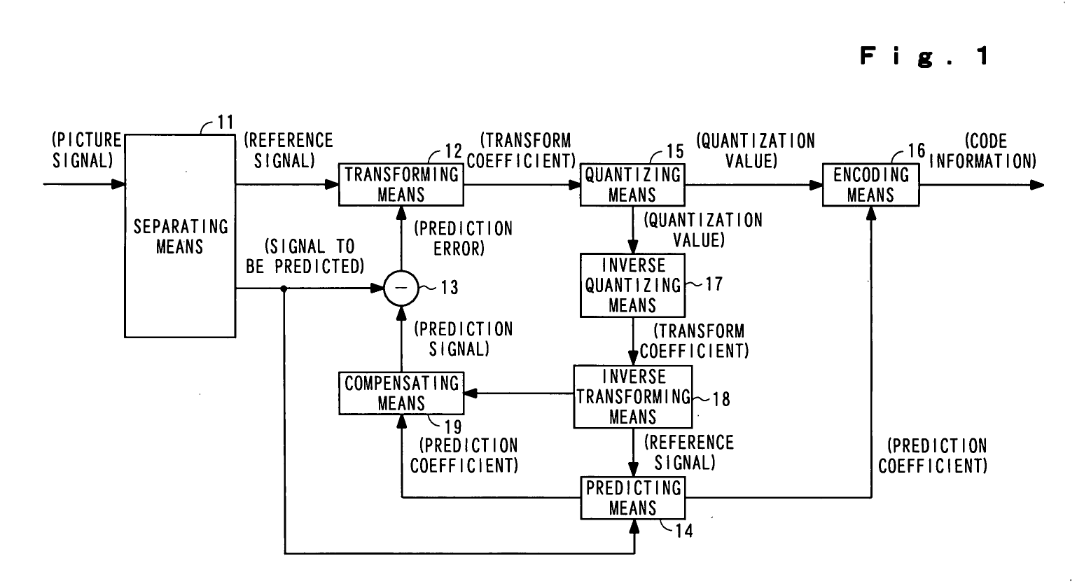

The present invention will be described hereinafter with reference to the drawing. FIG. 1 is a block diagram showing an embodiment of a picture encoding device according to the present invention. The function of each part of the picture encoding device shown in FIG. 1 will be described in order hereinafter.

Separating means 11 separates an input picture signal into a plurality of signals for every picture. In the present embodiment, the picture signal is a pixel signal. One of the signals separated by the separating means 11 becomes a reference signal as a reference in predicting means described below, another signal becomes a signal to be predicted. There may be a plurality of signals to be predicted.

In the separation of the separating means 11, for example, a signal mapped to an arbitrary color space such as an RGB signal, YUV signal or YCbCr signal can be used, and the type and number of signals to be separated are not limited. When the signal mapped to the arbitrary color space is separable by the separating means 11, the separating means 11 can cope with various input picture signals. It is preferable that a signal having a high resolution or a variable signal is employed as a reference signal in order to improve the prediction accuracy. For example, when the YUV signal is used, it is preferable that the Y signal is used as a reference signal and the U and V signals are used as signals to be predicted.

The reference signal separated by the separating means 11 is transmitted to transforming means 12, and the signal to be predicted is transmitted to difference calculating means 13 and predicting means 14. The transforming means 12 encodes the reference signal transmitted from the separating means 11 or a prediction error signal transmitted from the difference calculating means 13 by orthogonal transform and transforms it to a signal of frequency domain (orthogonal transform coefficients) DCT, approximate transform of the DCT, DWT, etc., can be used for the orthogonal transform. Transform coefficients obtained by the tranforming means 12 are transmitted to quantizing means.

The quantizing means 15 quantizes the transform coefficients transmitted from the transforming means 12. When the transform coefficients transmitted from the transforming means 12 correspond to the reference signal, quantization values obtained by the quantization are transmitted to encoding means 16 and inverse quantizing means 17. When the transform coefficients transmitted from the transforming means 12 correspond to the signal to be predicted, quantization values obtained by quantization are transmitted only to the encoding means 16.

Quantization parameters used for quantizing processing in the quantizing means 15 may be set as a combination of constant values, or may be controlled in accordance with the amount of information of the generated transform coefficients to keep an outputted bit rate fix.

The encoding means 16 encodes the quantized transform coefficients transmitted from the quantizing means 15 and a prediction coefficient transmitted from the predicting means 14 and outputs them as encoded information. Variable length encoding or arithmetic encoding, which removes redundancy between codes, can be used for the encoding of the quantized transform coefficients by the encoding means 16.

The inverse quantizing means 17 goes through the inverse steps of the quantizing processing by the quantizing means 15 to inversely quantize the quantized transform coefficients transmitted from the quantizing means 15. The transform coefficients inversely quantized by the inverse quantizing means 17 are transmitted to the inverse transforming means 18. The transform coefficients include quantization error.

The inverse transforming means 18 goes through the inverse steps of the orthogonal transform processing by the transforming means 12 to perform inverse orthogonal transform of the transform coefficients including the quantization error transmitted from the inverse quantizing means 17. A reference signal including the quantization error is generated by the inverse transforming means 18. The reference signal is transmitted to the predicting means 14 and compensating means 19.

The predicting means 14 calculates prediction coefficient for approximating the signal to be predicted transmitted from the separating means 11 based on the reference signal including the quantization error transmitted from the inverse transforming means 18. The signal to be predicted correspond to the same picture as the reference signal. The prediction coefficient calculated by the predicting means 14 is transmitted to the compensating means 19 and the encoding means 16.

The predicting means 14 uses, for example, the multiplier a of linear combination and the correction value b as prediction coefficients, and estimates the prediction coefficients for approximating the signal to be predicted based on the reference signal and the prediction coefficients in a unit of a small region. Moreover, when the YUV signal is used and the resolutions of YUV signals are different from each other due to sampling, it is necessary that resolution conversion makes the resolutions correspond to each other. Since the resolution of the Y signal is generally high, it is preferable that the Y signal is used as a reference signal and the U and V signals are used as signals to be predicted.

In the case where the Y signal is used as a reference signal and the U and V signals are used as signals to be predicted, when a coordinate which belongs to a certain small region is defined as (x, y) and pixel values of the YUV signals are respectively defined as Y(x, y), U(x, y) and V(x, y), predictions of the U signal and V signal at the coordinate (x, y) can be obtained by the expression (1). Moreover, the reference signal Y(x, y) includes the quantization error, and thus transmission of an error can be prevented.

[Expression 1]
U(x, y)=aᵤY(x, y)+bᵤ
∀(x, y)εR (1)
V(x, y)=aᵥY(x, y)+bᵥ

The prediction coefficients aᵤ, bᵤ, aᵥ, bᵥ are estimated so as to make the errors between the reference signal Y(x, y) including the quantization error and each of the signals to be predicted U(x, y) and V(x, y) minimum. A square of the prediction error can be used as an evaluation reference when the prediction coefficient is estimated. A concrete calculation method in the case where the prediction coefficients aᵤ and bᵤ are estimated to the U signal will be described hereinafter.

First, the square error Eᵤ² of the predicted U signal is represented by the expression (2).
[Expression 2]

$${E}_{u}^{2} = {\sum }_{( x , y ) ∈ R} {\{ {a}_{u} Y ( x , y ) + {b}_{u} - U ( x , y ) \}}^{2} \qquad ( 2 )$$

At this time, a partial differential of the square error Eᵤ² based on the prediction coefficients aᵤ and bᵤ is represented by the expression (3). Moreover, n represents the number of pixels that belong to the small region R.
[Expression 3]

$$\begin{matrix}\frac{\partial {E}_{u}^{2}}{\partial {a}_{u}} = 2 {a}_{u} {\sum }_{( x , y ) ∈ R} Y ( x , y ) - 2 {\sum }_{( x , y ) ∈ R} Y ( x , y ) U ( x , y ) + \\ 2 {b}_{u} {\sum }_{( x , y ) ∈ R} Y ( x , y )\end{matrix} \\ \frac{\partial {E}_{u}^{2}}{\partial {a}_{u}} = 2 {nb}_{u} - 2 {\sum }_{( x , y ) ∈ R} U ( x , y ) + 2 {a}_{u} {\sum }_{( x , y ) ∈ R} Y ( x , y ) \qquad ( 3 )$$

It is necessary that the expression (3) becomes zero in order to minimize the square error Eᵤ². Therefore, the prediction coefficients aᵤ and bᵤ can be calculated when the expression (4) is solved.
[Expression 4]

$$( \begin{matrix}{\sum }_{( x , y ) ∈ R} {Y ( x , y )}^{2} & {\sum }_{( x , y ) ∈ R} Y ( x , y ) \\ {\sum }_{( x , y ) ∈ R} Y ( x , y ) & n\end{matrix} ) ( \begin{matrix}{a}_{u} \\ {b}_{u}\end{matrix} ) = ( \begin{matrix}{\sum }_{( x , y ) ∈ R} Y ( x , y ) U ( x , y ) \\ {\sum }_{( x , y ) ∈ R} U ( x , y )\end{matrix} ) \qquad ( 4 )$$

The expression (4) is a linear simultaneous equation including the sum and the square sum of the reference signals including the quantization errors, the sum of the signals to be predicted and the product sum of the reference signal including the quantization errors and the signals to be predicted as to each small region, and becomes a derivation expression capable of calculating the prediction coefficients. When the expression (4) is algebraically solved, the multiplier aᵤ and the correction value bᵤ as prediction coefficients for minimizing the square error Eᵤ² are represented by the expression (5).
[Expression 5]

$${a}_{u} = \frac{n {\sum }_{( x , y ) ∈ R} Y ( x , y ) U ( x , y ) - {\sum }_{( x , y ) ∈ R} Y ( x , y ) {\sum }_{( x , y ) ∈ R} U ( x , y )}{n {\sum }_{( x , y ) ∈ R} {\{ Y ( x , y ) \}}^{2} - {\{ {\sum }_{( x , y ) ∈ R} Y ( x , y ) \}}^{2}} \\ {b}_{u} = \frac{1}{n} ( {\sum }_{( x , y ) ∈ R} U ( x , y ) - {a}_{u} {\sum }_{( x , y ) ∈ R} Y ( x , y ) ) \qquad ( 5 )$$

As apparent from the expression (5), the correction value bᵤ is derived with use of the multiplier a_{u.} Since the correction value bᵤ absorbs the quantization error of the quantized multiplier au when the multiplier aᵤ is quantized and encoded, the above prediction method can improve the prediction accuracy. That is, another prediction coefficient is derived with use of a prediction coefficient including a quantization error so that the prediction accuracy can be improved.

The concrete calculation method in the case of estimating the prediction coefficients aᵤ and bᵤ to the U signal has been described above, and similarly the prediction coefficients aᵥ and bᵥ can be estimated to the V signal only by substituting V(x, y) for U(x, y) of the expression (5).

The compensating means 19 generates the prediction signal for approximating the signal to be predicted based on the prediction coefficient transmitted from the predicting means 14 and the reference signal including the quantization error transmitted from the inverse transforming means 18. As described in the above example, when the predicting means 14 uses the linear combination and the prediction signal is constituted by the multiplier a and the correction value b, the prediction signal is generated in accordance with the expression (1). The prediction signal generated by the compensating means 19 is transmitted to the difference calculating means 13.

The difference calculating means 13 calculates a difference between the signal to be predicted separated by the separating means 11 and the prediction signal transmitted from the compensating means 19 and generates a prediction error signal. The signals to be predicted in this case also correspond to the same picture as the reference signals. The prediction error signal generated by the difference calculating means 13 is transmitted to the converting means 12 to be subjected to the orthogonal transform.

As apparent from the above the respective functions of the means, since the reference signal is at first encoded and the prediction error signal after reduction of the redundancy between the signal to be predicted and the reference signal is encoded for every image, the redundancy in one picture, which cannot be reduced by conventional arts, can be reduced. Moreover, information encoded by the above picture encoding device can be decoded when inverse steps of the encoding processing are performed.

The embodiment has been described above, but various modifications are applicable to the present invention. For example, the prediction method using the two prediction coefficients, the multiplier au (weighting coefficient) and the correction value bᵤ (offset coefficient), was used in the above embodiment. This prediction method is simple. However, other prediction methods can be used. Additionally, various changes among the prediction methods may be performed.

For example, only a weighting coefficient can be used as a prediction coefficient in the above embodiment. When the picture signal is an RGB signal, a more complicated prediction method can be used such that the R and G signals are used as reference signals and the B signal is predicted with use of a prediction expression, B(x, y)=aR(x, y)+bG(x, y)+c (a, b, c: prediction coefficients).

Additionally, although the pixel signal was used as an input picture signal, transform coefficients subjected to the orthogonal transform may be used as an input picture signal. In this case, transforming means and inverse transforming means are unnecessary, and the other means are processed in a transform encoded coefficient domain. Additionally, the function of the transforming means or the inverse transforming means is made to run or not to run so as to be able to cope with both the pixel signal and the transform coefficients.

Further, when a prediction method for reducing temporal redundancy, etc., is combined with the method for predicting an object to be encoded from information correlative to each picture and encoding the prediction error according to the present invention, each temporal redundancy of the reference signal and the signal to be predicted can be reduced and therefore higher encoding efficiency can be obtained.

What is claimed is:

1. A picture encoding device comprising:
separating means for separating a picture signal into a reference signal and one or more signals to be predicted for every picture;
converting means for performing orthogonal transform of the reference signal or a prediction error signal and outputting transform coefficients;
quantizing means for quantizing the transform coefficients and outputting quantized transform coefficients;
encoding means for encoding the quantized transform coefficients;
inverse quantizing means for inversely quantizing only the transform coefficients of the reference signal among the quantized transform coefficients;
inverse transforming means for inversely transforming the inversely quantized transform coefficients and outputting the reference signal including quantization error;
predicting means for estimating prediction coefficient for approximating the signal to be predicted based on the reference signal including the quantization error;
compensating means for generating a prediction signal of a signal to be predicted from the reference signal including the quantization error and the prediction coefficient; and
difference calculating means for calculating a difference between the signal to be predicted and the prediction signal and using the difference as the prediction error signal.

2. A picture encoding device comprising:
separating means for separating a picture signal constituted by orthogonal transform coefficients into a reference signal and one or more signals to be predicted for every picture;
quantizing means for quantizing the reference signal or a prediction error signal and outputting quantized transform coefficients;
encoding means for encoding the quantized transform coefficients;
inverse quantizing means for inversely quantizing only the transform coefficients of a reference signal among the quantized transform coefficients;
predicting means for estimating prediction coefficient for approximating the signal to be predicted based on a reference signal including quantization error transmitted from the inverse quantizing means;
compensating means for generating a prediction signal of a signal to be predicted from the reference signal including the quantization error and the prediction coefficient; and
difference calculating means for calculating a difference between the signal to be predicted and the prediction signal and using the difference as the prediction error signal.

3. The picture encoding device according to claim 1, wherein the separating means uses a variable signal as a reference signal among the input picture signal.

4. The picture encoding device according to claim 2, wherein the separating means uses a variable signal as a reference signal among the input picture signal.

5. The picture encoding device according to claim 1, wherein the separating means can separate a signal mapped to an arbitrary color space.

6. The picture encoding device according to claim 2, wherein the separating means can separate a signal mapped to an arbitrary color space.

7. The picture encoding device according to claim 1, wherein the separating means can separate a signal mapped to YUV color space, and uses Y signal as a reference signal, U signal and V signal as signals to be predicted.

8. The picture encoding device according to claim 2, wherein the separating means can separate a signal mapped to YUV color space, and uses Y signal as a reference signal, U signal and V signal as signals to be predicted.

9. The picture encoding device according to claim 1, wherein the predicting means is constituted so as to be able to cope with an arbitrary prediction method and prediction coefficient.

10. The picture encoding device according to claim 2, wherein the predicting means is constituted so as to be able to cope with an arbitrary prediction method and prediction coefficient.

11. The picture encoding device according to claim 1, wherein the predicting means estimates one or more prediction coefficients for every small region of a picture.

12. The picture encoding device according to claim 2, wherein the predicting means estimates one or more prediction coefficients for every small region of a picture.

13. The picture encoding device according to claim 1, wherein the predicting means estimates one or more prediction coefficients constituted by a multiplier and a correction value.

14. The picture encoding device according to claim 2, wherein the predicting means estimates one or more prediction coefficients constituted by a multiplier and a correction value.

15. The picture encoding device according to claim 1, wherein the predicting means estimates one or more prediction coefficients for minimizing error between the reference signal including the quantization error and the signal to be predicted.

16. The picture encoding device according to claim 2, wherein the predicting means estimates one or more prediction coefficients for minimizing error between the reference signal including the quantization error and the signal to be predicted.

17. The picture encoding device according to claim 15, wherein the predicting means uses a square of the error between the reference signal including the quantization error and the signal to be predicted as an evaluation reference when the prediction coefficients are estimated.

18. The picture encoding device according to claim 16, wherein the predicting means uses a square of the error between the reference signal including the quantization error and the signal to be predicted as an evaluation reference when the prediction coefficients are estimated.

19. The picture encoding device according to claim 17, wherein the predicting means estimates the prediction coefficients for making an expression, in which the square of the error is partly differentiated by the prediction coefficients, zero as the prediction coefficients for minimizing the error between the reference signal including the quantization error and the signal to be predicted.

20. The picture encoding device according to claim 18, wherein the predicting means estimates the prediction coefficients for making an expression, in which the square of the error is partly differentiated by the prediction coefficients, zero as the prediction coefficients for minimizing the error between the reference signal including the quantization error and the signal to be predicted.

21. The picture encoding device according to claim 17, wherein the predicting means estimates one or more prediction coefficients for every small region of a picture, and uses a derivation expression of a linear simultaneous equation including the sum and the square sum of the reference signal including the quantization errors, the sum of the signal to be predicted and the product sum of the reference signal including the quantization errors and the signal to be predicted as to the small regions, and coefficients of the equation are the prediction coefficients.

22. The picture encoding device according to claim 18, wherein the predicting means estimates one or more prediction coefficients for every small region of a picture, and uses a derivation expression of a linear simultaneous equation including the sum and the square sum of the reference signal including the quantization errors, the sum of the signal to be predicted and the product sum of the reference signal including the quantization errors and the signal to be predicted as to the small regions, and coefficients of the equation are the prediction coefficients.

23. The picture encoding device according to claim 21, wherein the predicting means estimates the prediction coefficients by algebraically solving the derivation expression.

24. The picture encoding device according to claim 22, wherein the predicting means estimates the prediction coefficients by algebraically solving the derivation expression.

25. The picture encoding device according to claim 21, wherein the predicting means derives another prediction coefficient by using a prediction coefficient including quantization error.

26. The picture encoding device according to claim 22, wherein the predicting means derives another prediction coefficient by using a prediction coefficient including quantization error.
